(19) United States
(12) Patent Application Publication
(10) Pub. No.: US 2025/0332796 A1
(43) Pub. Date: Oct. 30, 2025

(54) THREE DIMENSIONAL MOLDED OBJECT MANUFACTURING METHOD

(71) Applicant: SEIKO EPSON CORPORATION, Tokyo (JP)

(72) Inventor: Wataru ENDO, SHIOJIRI-SHI (JP)

(21) Appl. No.: 19/188,251

(22) Filed: Apr. 24, 2025

(30) Foreign Application Priority Data
Apr. 26, 2024 (JP) 2024-072135

(51) Int. Cl. B29C 64/40; B22F 10/22; B22F 10/40; B28B 1/00; B29C 64/118; B29L 31/00; B33Y 10/00

(52) U.S. Cl. CPC B29C 64/40; B22F 10/22; B22F 10/40; B28B 1/001; B29C 64/118; B33Y 10/00; B22F 2998/10; B29L 2031/772

(57) ABSTRACT

A three dimensional molded object manufacturing method that includes a first step of molding a molded object having a first overhang section by ejecting a first molding material and stacking molding layers and a second step of molding a brim structure by ejecting a second molding material and stacking brim layers, wherein the brim structure includes a first brim layer adjacent to and in contact with at least a part of the molding layer positioned at the lowermost layer of the molded object, and a second brim layer stacked on the first brim layer and adjacent to and in contact with at least a part of the first overhang section and the brim structure is a structure to be separated from the molded object formed in the first step.

The present application is based on, and claims priority from JP Application Serial Number 2024-072135, filed Apr. 26, 2024, the disclosure of which is hereby incorporated by reference herein in its entirety.

### BACKGROUND

### 1. Technical Field

The present disclosure relates to three dimensional molded object manufacturing method.

### 2. Related Art

JP-A-2019-72943 discloses that, in order to suppress the occurrence of warp during the molding of a three dimensional molded object, a circular brim is molded so as to contact the section of the outer periphery of the molded object layer where warp is expected to occur.

Even when the circular brim is molded, there is a possibility that the occurrence of warp in the three dimensional molded object cannot be suppressed depending on the mold of the three dimensional molded object.

### SUMMARY

According to a first aspect of the present disclosure, there is provided a three dimensional molded object manufacturing method. This manufacturing method includes a first step of molding a molded object having a first overhang section by ejecting a first molding material and stacking molding layers and a second step of molding a brim structure by ejecting a second molding material and stacking brim layers, wherein the brim structure includes a first brim layer adjacent to and in contact with at least a part of a molding layer positioned in a lowermost layer of the molded object, and a second brim layer stacked on the first brim layer and that is adjacent to and in contact with at least a part of the first overhang section and the brim structure is a structure to be separated from the molded object that was molded in the first step.

### BRIEF DESCRIPTION OF THE DRAWINGS

FIG. 1 is an explanatory view showing a schematic configuration of a three dimensional molding device. FIG. 2 is a perspective view showing a schematic configuration of a flat screw.

FIG. 3 is a schematic plan view of a barrel.

FIG. 4 is an explanatory view schematically showing a basic operation of the three dimensional molding device.

FIG. 5 is a flowchart of the three dimensional molding process.

FIG. 6 is an explanatory view schematically showing a side cross-section of a molded object and a brim structure.

FIG. 7 is an explanatory view showing the shapes of a first brim layer and a second brim layer as viewed from above.

FIG. 8 is an explanatory view schematically showing a side cross-section of the molded object and the brim structure in a second embodiment.

FIG. 9 is an explanatory view schematically showing a side cross-section of the molded object and the brim structure in a third embodiment.

FIG. 10 is an explanatory view showing the shapes of the first brim layer and the second brim layer in the third embodiment as viewed from above.

FIG. 11 is an explanatory view schematically showing a side cross-section of the molded object and the brim structure in a fourth embodiment.

FIG. 12 is an explanatory view schematically showing a side cross-section of the molded object and the brim structure in a fifth embodiment.

FIG. 13 is a top view showing a molding layer, a brim layer, and a brim support layer.

FIG. 14 is an explanatory view schematically showing a side cross-section of the molded object and the brim structure in a sixth embodiment.

FIG. 15 is a diagram showing a modification of the sixth embodiment.

FIG. 16 is an explanatory view schematically showing a side cross-section of the molded object and the brim structure in a seventh embodiment.

### DESCRIPTION OF EMBODIMENTS

### A. First Embodiment

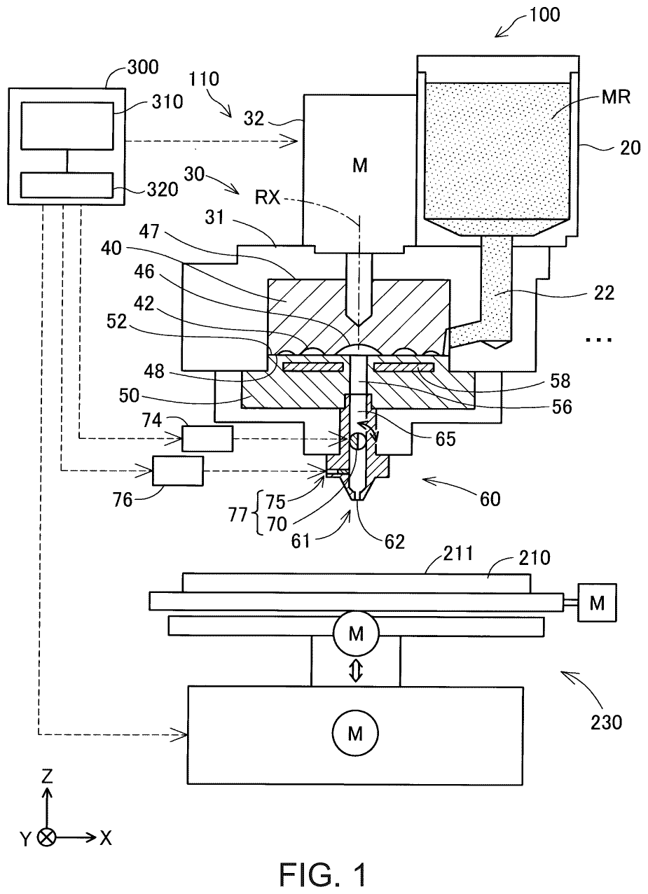

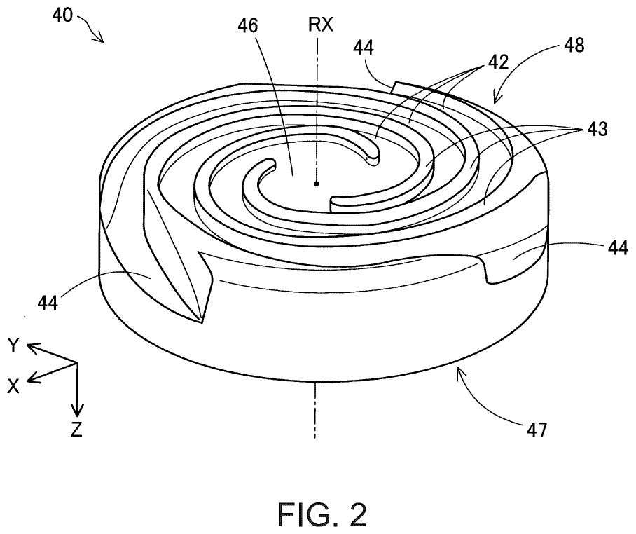

FIG. 1 is an explanatory view showing a schematic configuration of a three dimensional molding device 100 in a first embodiment. In FIG. 1, arrows indicating X, Y, and Z directions orthogonal to each other are shown. The X direction and the Y direction are directions parallel to a horizontal plane, and the Z direction is a direction along a vertically upward direction. The arrows indicating the X, Y, and Z directions are appropriately shown in other drawings so that the shown directions correspond to those in FIG. 1. In the following description, when a direction is specified, a direction indicated by an arrow in each drawing is referred to as “+” and an opposite direction is referred to as “−”, and positive and negative signs are used in combination for direction notation. Hereinafter, a +Z direction is also referred to as “upper”, and a −Z direction is also referred to as “lower”.

The three dimensional molding device 100 of the present embodiment is a device that molds a three dimensional molded object by a material extrusion method. The three dimensional molding device 100 includes a molding section 110 that generates and ejects molding material, a stage 210 serving as a base for the three dimensional molded object, a movement mechanism 230 that controls the eject position of the molding material, and a control section 300 that controls each section of the three dimensional molding device 100. In FIG. 1, one molding section 110 is shown, but in the present embodiment, a plurality of molding sections 110 that generate and eject different molding materials are provided in the three dimensional molding device 100. The configuration of each molding section 110 is the same.

The molding section 110 ejects molding material, which is plasticized from solid state material, onto the stage 210 under the control of the control section 300. The molding section 110 includes a material supplying section 20, which is the supply source of raw material before it is converted into molding material, a plasticizing section 30, which converts the raw material into molding material, and an ejection section 60, which ejects the molding material.

The material supplying section 20 supplies raw material MR to the plasticizing section 30. The material supplying section 20 is constituted by, for example, a hopper that accommodates the raw material MR. The material supplying section 20 is connected to the plasticizing section 30 via a communication path 22. The raw material MR is supplied to the material supplying section 20 in the form of pellets, powder, or the like. As the raw material MR, for example, a resin material such as acrylonitrile butadiene styrene (ABS), polyether ether ketone (PEEK), or polypropylene (PP) is used. The raw material MR may contain an inorganic material such as a metal or a ceramic.

The plasticizing section 30 plasticizes the raw material MR, which is supplied from the material supplying section 20, to generate a paste-like molding material, which has fluidity, and leads it to the ejection section 60. In the present embodiment, “plasticization” means a concept including melting, and means a change from a solid state to a fluid state. Specifically, in the case of a material in which glass transition occurs, plasticization means that the temperature of the material is set to be equal to or higher than the glass transition point. For material that does not undergo glass transition, “plasticization” means that the temperature of the material is raised to or above the melting point.

The plasticizing section 30 has a screw case 31, a drive motor 32, a flat screw 40, and a barrel 50. The flat screw 40 is also referred to as a rotor or scroll. The barrel 50 is also called a screw facing section.

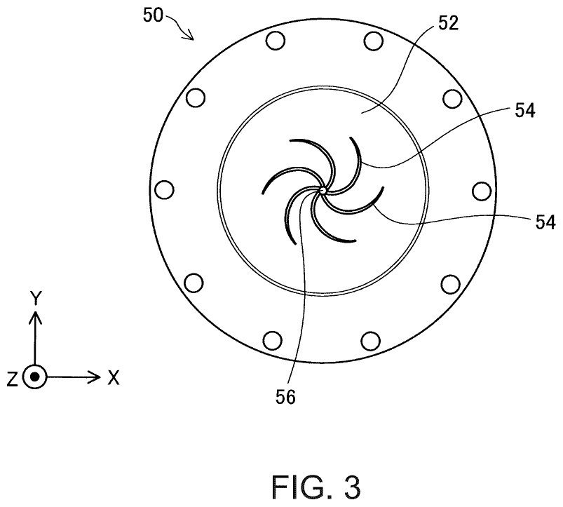

FIG. 2 is a perspective view showing a schematic configuration of a lower surface 48 side of the flat screw 40. The flat screw 40 shown in FIG. 2 is shown with the positional relationship between an upper surface 47 and the lower surface 48 shown in FIG. 2 reversed in the vertical direction for facilitating understanding of the technology. FIG. 3 is a schematic plan view showing a upper surface 52 side of the barrel 50. The flat screw 40 has a substantially cylindrical shape whose length in an axial direction, which is a direction along its central axis, is smaller than a length in a direction perpendicular to the axial direction. The flat screw 40 is disposed so that a rotation axis RX, which serves as a rotation center of the flat screw 40, is parallel to the Z direction.

As shown in FIG. 1, the flat screw 40 is housed in the screw case 31. An upper surface 47 of the flat screw 40 is connected to the drive motor 32, and the flat screw 40 is rotated in the screw case 31 by a rotational drive force generated by the drive motor 32. The drive motor 32 is driven under the control of the control section 300. Note that the flat screw 40 may be driven by the drive motor 32 via a reduction gear.

As shown in FIG. 2, vortex shape groove sections 42 are formed on the lower surface 48 of the flat screw 40, which is a surface intersecting the rotation axis RX. The communication path 22 of the material supplying section 20 described above communicates with the groove sections 42 from the side surface of the flat screw 40. In this embodiment, three groove sections 42, which are spaced apart, are formed by ridge sections 43. Note that the number of groove portions 42 is not limited to three, and may be one or two or more. The groove sections 42 are not limited to a vortex shape, may be helical or involute curvilinear, and may extend so as to draw an arc from the central section to the outer periphery.

The lower surface 48 of the flat screw 40 faces the upper surface 52 of the barrel 50, and a space is formed between the groove section 42 of the lower surface 48 of the flat screw 40 and the upper surface 52 of the barrel 50. The raw material MR is supplied into this space between the flat screw 40 and the barrel 50 from the material supplying section 20 through a material inflow port 44 shown in FIG. 2.

As shown in FIG. 1, a barrel heater 58 for heating the raw material MR supplied into the groove sections 42 of the rotating flat screw 40 is embedded in the barrel 50. A communication hole 56 is provided at the center of the barrel 50. As shown in FIG. 3, the upper surface 52 of the barrel 50 is formed with a plurality of guide grooves 54 which are connected to the communication hole 56 and extend in a vortex shape from the communication hole 56 toward the outer periphery. Note that one end of the guide grooves 54 may not be connected to the communication hole 56. It is also possible to omit the guide grooves 54.

The raw material MR supplied into the groove sections 42 of the flat screw 40 flows along the groove sections 42 by the rotation of the flat screw 40 while being plasticized in the groove sections 42, and is guided to the central section 46 of the flat screw 40 as the molding material. The paste-like molding material, which has fluidity and flowed into the central section 46, is supplied to the ejection section 60 through the communication hole 56 provided in the center of the barrel 50. Note that in the molding material, not all types of substances that constitute the molding material need to be plasticized. The molding material should be converted into a state having fluidity as a whole by plasticizing at least some kinds of substances that constitute the molding material.

The ejection section 60 of FIG. 1 includes a nozzle 61 that ejects the molding material, a flow path 65 of the molding material provided between the flat screw 40 and a nozzle opening 62, and an ejection control section 77 that controls the eject of the molding material.

The nozzle 61 is connected to the communication hole 56 of the barrel 50 via the flow path 65. The nozzle 61 ejects the molding material generated in the plasticizing section 30 from the nozzle opening 62, which is the tip end section of the nozzle 61, toward the stage 210.

The ejection control section 77 includes an ejection adjustment section 70 that opens and closes the flow path 65, and a suction section 75 that sucks and temporarily stores the molding material.

The ejection adjustment section 70 is provided in the flow path 65, and changes the opening degree of the flow path 65 by rotating in the flow path 65. In the present embodiment, the ejection adjustment section 70 is constituted by a valve. The ejection adjustment section 70 is driven by a first drive section 74 under the control of the control section 300. The first drive section 74 is constituted by, for example, a stepping motor. The control section 300 can adjust the flow rate of the molding material flowing from the plasticizing section 30 to the nozzle 61, that is, the ejection amount of the molding material ejected from the nozzle 61 by controlling the rotation angle of the valve using the first drive section 74. The ejection adjustment section 70 can adjust the ejection amount of the molding material and can control the ON and OFF of the outflow of the molding material.

The suction section 75 is connected between the ejection adjustment section 70 and the nozzle opening 62 in the flow path 65. The suction section 75 temporarily sucks the molding material from the flow path 65 when the eject of the molding material from nozzle 61 is stopped, thereby suppressing a tail-dragging phenomenon where the molding material drips from nozzle opening 62 in a string-like manner. In the present embodiment, the suction section 75 is constituted by a plunger. The suction section 75 is driven by a second drive section 76 under the control of the control section 300. The second drive section 76 is constituted by, for example, a stepping motor and a rack and pinion mechanism that converts the rotational force of the stepping motor into the translational movement of the plunger.

The stage 210 is positioned at a position facing the nozzle opening 62 of the nozzle 61. In the first embodiment, a molding surface 211 of the stage 210 facing the nozzle opening 62 of the nozzle 61 is disposed so as to be parallel to the X and Y directions, that is, a horizontal direction. The stage 210 may be provided with a stage heater to suppress rapid cooling of the molding material ejected onto the stage 210.

The movement mechanism 230 changes the relative position between the stage 210 and the nozzle 61 under the control of the control section 300. In the present embodiment, the position of the nozzle 61 is fixed, and the movement mechanism 230 moves the stage 210. The movement mechanism 230 is constituted by a three axis positioner that moves the stage 210 in the three axis directions of X, Y, and Z by the driving forces of three motors. In the present specification, unless otherwise specified, movement of the nozzle 61 means that the nozzle 61 or the ejection section 60 is relatively moved with respect to the stage 210.

Note that in another embodiment, instead of the configuration in which the stage 210 is moved by the movement mechanism 230, a configuration may be adopted in which the position of the stage 210 is fixed and the movement mechanism 230 moves the nozzle 61 with respect to the stage 210. A configuration in which the movement mechanism 230 moves the stage 210 in the Z direction and the nozzle 61 in the X and Y directions, or a configuration in which the movement mechanism 230 moves the stage 210 in the X and Y directions and the nozzle 61 in the Z direction, may be adopted. Even using these configurations, the relative positional relationship between the nozzle 61 and the stage 210 can be changed.

The control section 300 is constituted by a computer including one or a plurality of processor 310, a storage section 320 including a main storage device and an auxiliary storage device, and an input/output interface that inputs and outputs signals to and from the outside. By executing a program stored in the storage section 320, the processor 310 controls the molding section 110 and the movement mechanism 230 in accordance with molding data stored in the storage section 320 to mold the three dimensional molded object on the stage 210. The molding data for molding the three dimensional molded object includes, for each layer obtained by slicing the shape of the three dimensional molded object into a plurality, path information representing a moving path of the nozzle 61 and ejection amount information representing an ejection amount of the molding material in each moving path. The movement path of the nozzle 61 is a path in which the nozzle 61 relatively moves along the molding surface 211 of stage 210 while ejecting the molding material. The modeling data is acquired, for example, from another computer connected to the control section 300 via a communication line or from a recording medium, and is stored in the storage section 320. Note that the control section 300 may be realized by a configuration of a combination of circuits, instead of being configured by the computer.

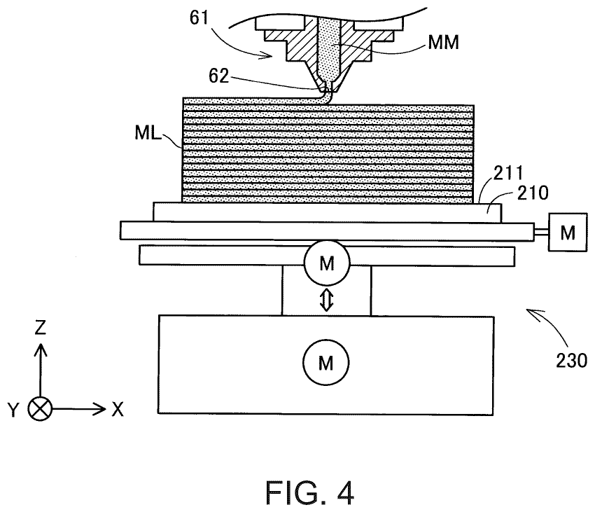

FIG. 4 is an explanatory view schematically showing a basic operation of the three dimensional molding device 100. In the three dimensional molding device 100, as described above, the molding material MM is generated by plasticizing the solid raw material MR. The control section 300 maintains the distance between the molding surface 211 of the stage 210 and the nozzle 61, and ejects molding material MM from the nozzle 61 in the direction along the molding surface 211 of the stage 210 while changing the position of the nozzle 61 with respect to the stage 210. The molding material MM ejected from the nozzle 61 is continuously deposited in the direction of movement of the nozzle 61.

The control section 300 repeats the movement of the nozzle 61 to form the molding layer ML. After forming one molding layer ML, the control section 300 relatively moves the position of nozzle 61 with respect to stage 210 in the +Z direction, which is the stacking direction of the molding layer ML. Then, the three dimensional molded object is molded by further stacking the molding layer ML on the molding layers ML molded so far. Hereinafter, the three dimensional molded object is also simply referred to as a molded object.

For example, when the nozzle 61 moves in the Z direction in a case where the molding layer ML for one layer is completed or when there is a plurality of independent molding regions in each molding layer the control section 300 may temporarily stop the ejection of the molding material from the nozzle 61. In this case, the ejection adjustment section 70 closes the flow path 65 to stop the ejection of the molding material MM from the nozzle opening 62 and the suction section 75 temporarily sucks the molding material inside the nozzle 61. After changing the position of the nozzle 61, the control section 300 resumes the deposition of the molding material MM from the changed position of the nozzle 61 by opening the flow path 65 via the ejection adjustment section 70 while ejecting the molding material in the suction section 75.

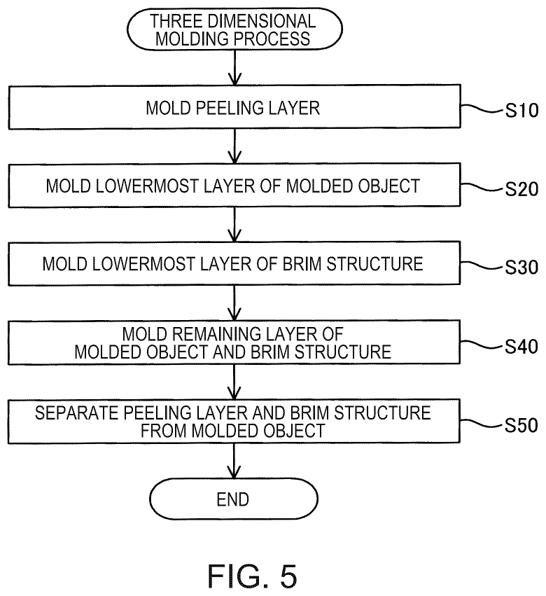

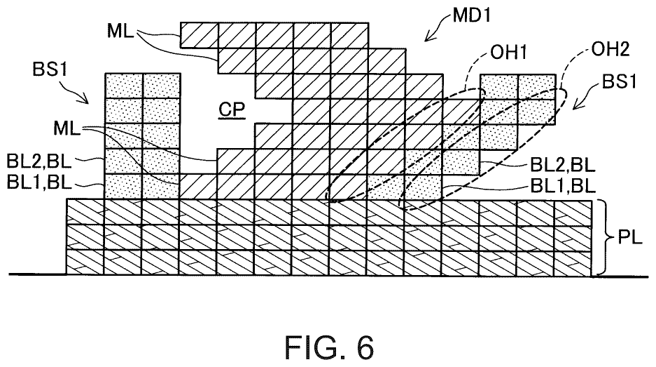

FIG. 5 is a flowchart of a three dimensional molding process executed by the control section 300. By executing the three dimensional molding process shown in FIG. 5, a three dimensional molded object manufacturing method is realized. FIG. 6 is an explanatory view schematically showing a side cross section of a molded object MD1 and a brim structure BS1 molded by the three dimensional molding process.

In step S10 of FIG. 5, the control section 300 controls the molding section 110 and the movement mechanism 230 to mold a peeling layer PL on the molding surface 211 of the stage 210. The peeling layer PL is also referred to as “raft”. The molding material for molding the peeling layer PL is, for example, PP. The peeling layer PL is a layer that allows the molded object MD1 and the brim structure BSI to be easily peeled from the stage 210. In FIG. 6, the peeling layer PL is molded by stacking three layers. The number of layers constituting the peeling layer PL is, for example, 1 to 10, and can be arbitrarily designated by the user. The peeling layer PL is utilized as a temporary stage. The data for molding the peeling layer PL may be included in the molding data or may be stored in the storage section 320 in advance.

In step S20 shown in FIG. 5, the control section 300 controls the molding section 110 that ejects the first molding material and the movement mechanism 230 to mold the lowermost layer of the molded object MD1 on the peeling layer PL according to the molding data. The lowermost layer of the molded object MD1 is the molding layer ML constituting the bottom surface of the molded object MD1. The first molding material is, for example, ABS. In the present embodiment, the first molding material is a material different from the molding material for molding the peeling layer PL. That is, the peeling layer PL and the molded object MD1 are molded by ejecting different molding materials from different molding sections 110.

In step S30 shown in FIG. 5, the control section 300 controls the molding section 110 that ejects the second molding material and the movement mechanism 230 to mold the lowermost layer of the brim structure BSI on the peeling layer PL. The brim structure BS1 is a structure for suppressing the peeling of the molded object MD1 from the peeling layer PL. The control section 300 molds the brim layer BL positioned in the lowermost layer of the brim structure BS1 so as to be adjacent to and in contact with the molding layer ML positioned in the lowermost layer of the molded object MD1. The term “adjacent to and in contact with” means that they are placed next to each other and are in contact with each other. In the present embodiment, the second molding material used for molding the brim layer BL is the same material as the first molding material used for molding the molded object MD1. Therefore, the molding section 110 for ejecting the second molding material is the same molding section 110 as the molding section 110 for ejecting the first molding material. The data for molding the brim layer BL may be included in the molding data, or the control section 300 analyzes the molding data for molding the molded object MD1 and generates it so that the brim layer BL is molded around the molded object MD1. The second molding material used for molding the brim layer BL and the first molding material used for molding the molded object MD1 may be different materials.

The processing order of step S20 and step S30 described above may be reversed. That is, the brim layer BL positioned at the lowermost layer of the brim structure BSI may be molded before the molding layer ML positioned at the lowermost layer of the molded object MD1 is molded.

In step S40 of FIG. 5, the control section 300 controls the molding section 110 and the movement mechanism 230 to mold the remaining layer of the molded object MD1, that is, the molding layer ML other than the lowermost layer of the molded object MD1, and the remaining layer of the brim structure BS1, that is, the brim layer BL other than the lowermost layer of the brim structure BS1. By step S40, the molded object MD1 and the brim structure BS1 are molded on the peeling layer PL. The brim structure BS1 includes at least a first brim layer BL1 and a second brim layer BL2. The first brim layer BL1 is the brim layer BL that is adjacent to and in contact with at least a part of the molding layer ML positioned in the lowermost layer of the molding layer ML. The second brim layer BL2 is the brim layer BL stacked on the first brim layer BL1.

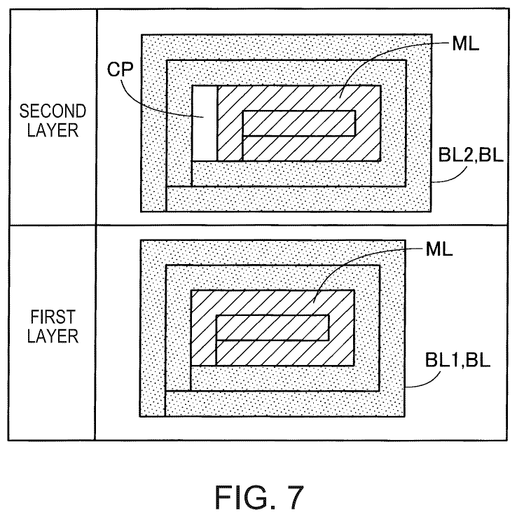

FIG. 7 is an explanatory view showing the shapes of the first brim layer BL1 and the second brim layer BL2 as viewed from above. As shown in FIG. 7, in the present embodiment, the brim layer BL is formed with a constant width along a path circling around the periphery of the molding layer ML. In the present embodiment, the first brim layer BL1 is in contact with the entire periphery of the molding layer ML positioned at the lowermost layer. The second brim layer BL2 is stacked on the first brim layer BL1 so as to overlap at least a portion of the first brim layer BL1.

Prior to the start of the three dimensional molding process, the control section 300 may receive designations from the user via an input interface provided in the control section 300, about the number of layers of the brim layer BL constituting the brim structure BS1 and the width of the brim layer BL in the in-plane direction. When the number of layers and the width are not designated by the user, a predetermined number of layers and a predetermined width are set. In the present embodiment, a common width is set as the width in the in-plane direction of each brim layer BL constituting the brim structure BS1. The widths of the brim layer BL in the in-plane direction are the dimensions of the brim layer BL in a direction vertically outward along the horizontal direction from the side surfaces of the molded object MD1. The width of the brim layer BL is not limited to the dimension value and may be designated by the number of rounds by the nozzle 61, which circles around the molding layer ML to mold the brim layer BL.

In step S50 of FIG. 5, the peeling layer PL and the brim structure BS1 are separated from the molded object MD1, which was molded by the processes of step S20 and step $40. The separation process in step S50 is performed manually or by a cutting device. The molded object MD1 is manufactured by the series of steps described above. The process of step S20 described above and the process of molding the molding layer ML in step S40 are collectively referred to as the “first step”. The process of step S30 and the process of molding the brim layer BL in step S40 are also collectively referred to as the “second step”.

FIG. 6 shows an example in which the molded object MD1 and the brim structure BS1 are molded on the peeling layer PL in the above described three dimensional molding process. The molded object MD1 includes a first overhang section OH1 and a constricted portion CP. The first overhang section OH1 is a portion that floats in the air after completion of the molded object MD1. The constricted portion CP is a portion of the molded object MD1 that is recessed in a direction intersecting the vertical direction. In other words, the constricted portion CP is a portion that is recessed toward the inside of the molded object MD1 on the side surface of the molded object MD. In FIG. 6, an upper half portion of the constricted portion CP has an overhang shape. However, in the present embodiment, the overhang shape included in the constricted portion CP does not correspond to the first overhang section OH1. In the example shown in FIG. 6, the molded object MD1 is molded by seven layers of molding layer ML. The brim structure BS1 is molded by five layers of brim layer BL.

In the present embodiment, in the above described step S40, the control section 300 molds the first overhang section OH1 and the constricted portion CP by stacking the plurality of molding layers ML having the same shapes and the same areas while horizontally shifting the molding positions. The control section 300 molds each brim layer BL so that each brim layer BL is adjacent to and in contact with at least a portion of the first overhang section OH1 and so that each brim layer BL is not adjacent to and in contact with the constricted portion CP. In this way, a brim structure BS1 is molded as shown in FIG. 6. The brim structure BS1 has a second overhang section OH2 and does not contact the constricted portion CP. The second overhang section OH2 supports the first overhang section OH1 of the molded object MD1 from below. In the brim structure BS1, the brim layers BL in the portion opposing the constricted portion CP in the horizontal direction are stacked in the vertically upward direction. As described above, in the present embodiment, the control section 300 allows the shape of each of the brim layers BL to change toward the outside of the molded object MD1 and prohibits the shape of each of the brim layers BL from changing toward the inside of the molded object MD1 when the second brim layer BL2 and the subsequent brim layers BL are stacked.

According to the first embodiment described above, the molded object MD1, which has the first overhang section OH1 and is constituted by the plurality of molding layers ML, and the brim structure BS1, which is constituted by the plurality of brim layers BL, are molded on the peeling layer PL so as to be adjacent to and in contact with each other at least in the lowermost layer. Therefore, the molded object MD1 can be desirably brought into close contact with the peeling layer PL as compared with the case where only the molded object MD1 is molded on the peeling layer PL or the case where only one layer of the brim layer BL is molded. As a result, it is possible to reduce the possibility that warp occurs in the molded object MD1.

Further, in the present embodiment, although the molded object MD1 has the constricted portion CP, the brim layer BL does not contact the constricted portion CP. Therefore, when the brim structure BS1 is separated from the molded object MD1, the brim structure BS1 can be suppressed from being fitted into the constricted portion CP. Therefore, the separability between the molded object MD1 and the brim structure BS1 can be enhanced.

In this embodiment, by stacking the brim layer BL of a common width in each layer, the brim structure BS1 is molded having the second overhang section OH2 that contacts at least a part of the first overhang section OH1 of the molded object MD1. Therefore, the first overhang section OH1 of the molded object MD1 can be supported by the second overhang section OH2 of the brim structure BS1. As a result, the molding accuracy of the molded object MD1 can be enhanced.

In the present embodiment, the brim layer BL is molded as the second molding material is ejected along a path circling around the molding layer ML. Therefore, since the brim layer BL is molded so as to be in contact with the entire molding layer ML, it is possible to increase the degree of adhesion of the molded object MD1 to the peeling layer PL as compared with a case where the brim layer BL is molded so as to be in contact with a part of the molding layer ML. As a result, it is possible to effectively suppress the occurrence of warp in the molded object MD1.

In the first embodiment, the control section 300 molds the molded object MD1 including the constricted portion CP. On the other hand, the control section 300 may mold a molded object that does not include the constricted portion CP.

### B. Second Embodiment

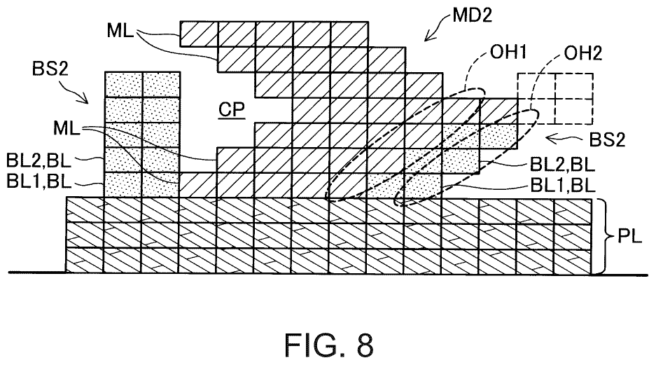

FIG. 8 is an explanatory view schematically showing a side cross-section of the molded object MD2 and a brim structure BS2 molded in a second embodiment. The second embodiment differs from the first embodiment in the method of molding the brim structure BS2 in the three dimensional molding process. The shape of the molded object MD2 is the same as that of the molded object MD1 in the first embodiment. Note that the configuration of the three dimensional molding device 100 in the second embodiment and subsequent embodiments is the same as the first embodiment.

In step S40 of the three dimensional molding process shown in FIG. 5 in the second embodiment, the control section 300 does not mold a protruding portion if the protruding portion protrudes outward from the molding region of the nth brim layer BL (counting from the lowermost layer), of the molding region of the n+1th brim layer BL counted up from the lowermost layer (n being a natural number), by a width equal to or more than a width set in common for each brim layer BL. In other words, when the n+1th brim layer BL and the nth brim layer BL have a non-overlapping region that does not overlap in the vertical direction by the above described width or more, the control section 300 does not mold the non-overlapping region of the n+1th brim layer BL. In FIG. 8, a portion which is not molded in the second embodiment is indicated by a rectangle in broken line.

According to the second embodiment described above, as shown by the rectangle in broken line in FIG. 8, it is possible to suppress the molding of a portion that does not contribute to the support of the first overhang section OH1 in the brim structure BS2. It is possible to suppress the brim structure BS2 from collapsing due to the weight of the outwardly protruding portion.

### C. Third Embodiment

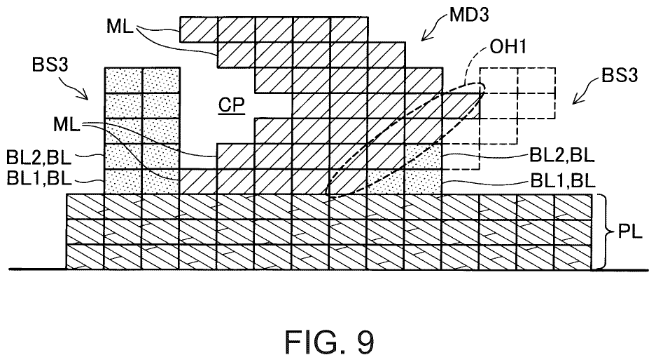

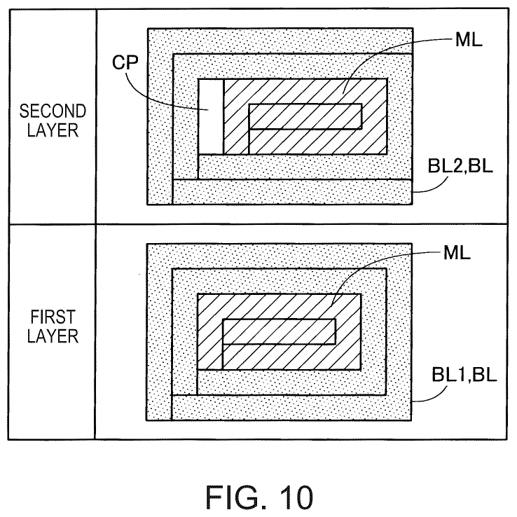

FIG. 9 is an explanatory view schematically showing a side cross-section of a molded object MD3 and a brim structure BS3 molded in a third embodiment. FIG. 10 is an explanatory view showing the shapes of the first brim layer BL1 and the second brim layer BL2 in the third embodiment as viewed from above. The third embodiment differs from the first embodiment in the method of molding the brim structure BS3 in the three dimensional molding process. The shape of the molded object MD3 is the same as that of the molded object MD1 in the first embodiment.

In step S40 of the three dimensional molding process shown in FIG. 5 in the third embodiment, the control section 300 does not mold the protruding portion when there is a portion among the molding region of the second brim layer BL2 and the third and subsequent brim layer BL that protrudes outward from the molding region of the first brim layer BL1. In other words, when there is a non-overlapping region which does not overlap with the first brim layer BL1 in the vertical direction in the second brim layer BL2 and the third and subsequent brim layer BL, the control section 300 does not form the non-overlapping region. In FIG. 9, a portion which is not molded in the third embodiment is indicated by a rectangle in broken line.

According to the third embodiment described above, the brim layer BL in the molding region exceeding the molding region of the brim layer BL in the lowermost layer is not stacked on the brim layer BL in the lowermost layer. Therefore, the second overhang section OH2 is not molded in the brim structure BS3. As a result, the brim structure BS3 with a stable shape can be molded.

### D. Fourth Embodiment

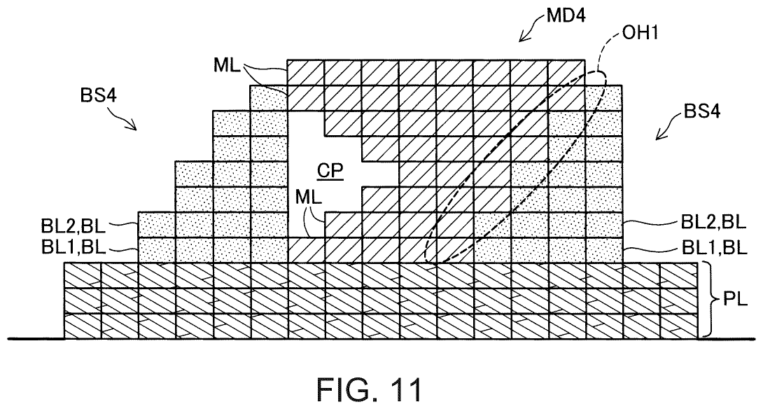

FIG. 11 is an explanatory view schematically showing a side cross-section of a molded object MD4 and a brim structure BS4 molded in a fourth embodiment. The fourth embodiment differs from the first embodiment in the method of molding the brim structure in the three dimensional molding process.

In step S40 of the three dimensional molding process shown in FIG. 5 in the fourth embodiment, the control section 300 molds the brim structure BS4 so that the width in the in-plane direction of the n+1th brim layer BL counted from the lowermost layer is equal to or less than the width in the in-plane direction of the nth brim layer BL counted from the lowermost layer. The initial value of the width of the brim layer BL may be arbitrarily designated by the user. Further, in the fourth embodiment, similarly to the first embodiment, the control section 300 molds each brim layer BL so as to be adjacent to and in contact with the first overhang section OH1 of the molded object MD4, and molds each brim layer BL so as not to be adjacent to and in contact with the constricted portion CP of the molded object MD4.

According to the fourth embodiment described above, since the width of the brim layer BL constituting the brim structure BS4 becomes smaller toward the vertically upper side, the brim structure BS4 can be formed in a stable posture with respect to the peeling layer PL. As a result, it is possible to effectively suppress the occurrence of warp in the molded object MD1. In the fourth embodiment, since the brim structure BS4 can be molded so that the second overhang section OH2 is not formed, the brim structure BS4 can be molded in a more stable posture with respect to the peeling layer PL.

### E. Fifth Embodiment

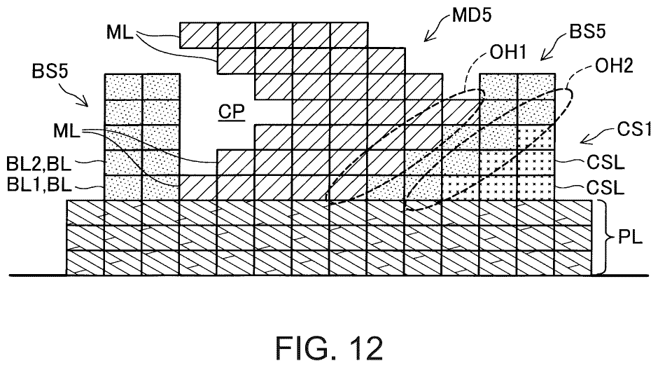

FIG. 12 is an explanatory view schematically showing a side cross section of a molded object MD5 and a brim structure BS5 molded in a fifth embodiment. The fifth embodiment differs from the first embodiment in the method of molding the brim structure in the three dimensional molding process. The shape of the molded object MD5 is the same as that of the molded object MD1 in the first embodiment.

In step S40 of the three dimensional molding process shown in FIG. 5 in the fifth embodiment, the control section 300 molds the brim structure BS5 having the same shape as the brim structure BS1 in the first embodiment, and molds a second brim structure CSI that supports the second overhang section OH2 of the brim structure BS5 from below.

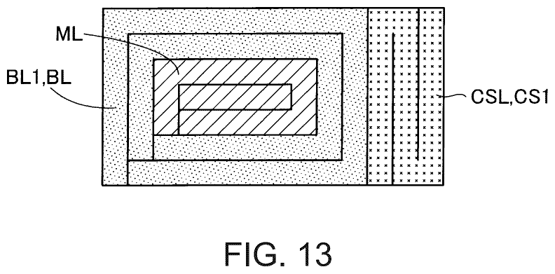

FIG. 13 is a top view showing the molding layer ML, the brim layer BL, and a brim support layer CSL that constitutes the second brim structure CS1, which are formed in the lowermost layer. Unlike the brim layer BL, the brim support layer BSL is molded by a path independent of the brim layer BL, not by a path circling around the molding layer ML.

According to the fifth embodiment described above, by molding the second brim structure CSI below the brim structure BS5, the second overhang section OH2 of the brim structure BS5 can be supported from below. Therefore, it is possible to suppress the occurrence of shape collapse in the brim structure BS5 and the molded object MD5. The second brim structure CS1 may be molded with the same molding material as the brim structure BS5 or may be molded with a different molding material.

### F. Sixth Embodiment

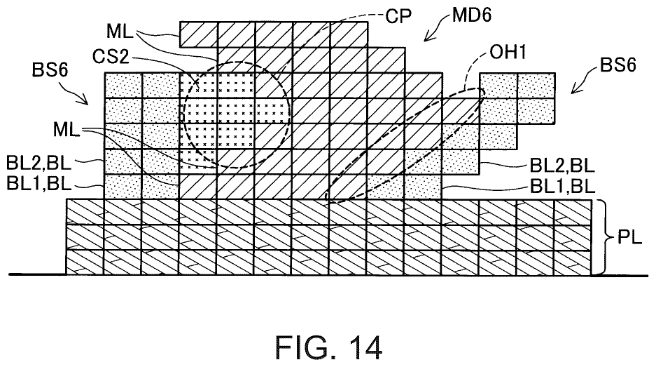

FIG. 14 is an explanatory view schematically showing a side cross section of a molded object MD6 and a brim structure BS6 molded in a sixth embodiment. The sixth embodiment differs from the first embodiment in the method of molding the brim structure in the three dimensional molding process. The shape of the molded object MD6 is the same as that of the molded object MD1 in the first embodiment.

In step S40 of the three dimensional molding process shown in FIG. 5 in the sixth embodiment, the control section 300 molds the brim structure BS6 having the same shape as the brim structure BS1 in the first embodiment, and molds a third brim structure CS2 with respect to the constricted portion CP of the molded object MD6. By molding such a third brim structure CS2, it is possible to suppress the collapse of the shape of the upper portion of the constricted portion CP of the molded object MD6. The third brim structure CS2 may be molded with the same molding material as the brim structure BS6 or it may be molded with a different molding material. When the third brim structure CS2 is molded using a water-soluble molding material, the third brim structure CS2 can be easily removed.

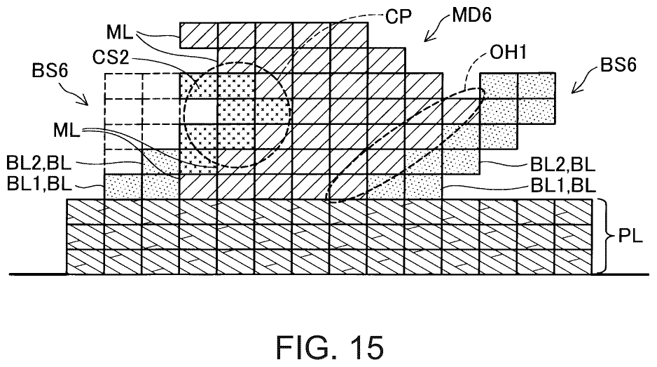

FIG. 15 is a diagram showing a modification of the sixth embodiment. In the sixth embodiment, since the third brim structure CS2 is molded in addition to the brim structure BS6, the consumption amount of the molding material increases. Therefore, as shown in FIG. 15, the control section 300 may mold only a range of a predetermined width adjacent to and in contact with the molded object MD6, out of the molding region obtained by combining the brim structure BS6 and the third brim structure CS2. In this way, it is possible to reduce the consumption amount of the molding material.

### G. Eventh Embodiment

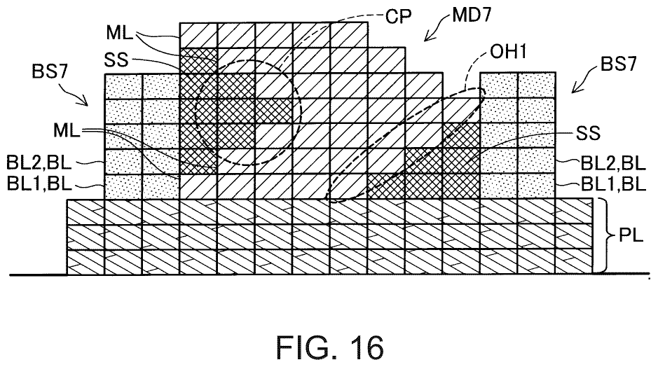

FIG. 16 is an explanatory view schematically showing a side cross section of a molded object MD7 and a brim structure BS7 molded in a seventh embodiment. The seventh embodiment differs from the first embodiment in the method of molding the brim structure in the three dimensional molding process. The shape of the molded object MD7 is the same as that of the molded object MD1 in the first embodiment.

In the seventh embodiment, the control section 300 molds a support structure SS below the first overhang section OH1 and in the constricted portion CP of the molded object MD7. The molding material for molding the support structure SS may be the same as or different from that of the molded object MD7 or the brim structure BS7. In the seventh embodiment, the control section 300 stacks the brim layer BL in accordance with a path circling around the periphery of the molding region obtained by combining the molded object MD7 and the support structure SS. Therefore, the brim structure BS7 has a shape that extends vertically upward, and the second overhang section OH2 is not formed.

According to the seventh embodiment described above, since the support structure SS for supporting the first overhang section OH1 and the constricted portion CP of the molded object MD7 is molded, the shape of the molded object MD7 is less likely to collapse. Since the brim structure BS7 is molded vertically upward around the molded object MD7 and the support structure SS, the molded object MD7 and the support structure SS can be desirably brought into close contact with the peeling layer PL.

### H. Other Embodiments

(H1) In the above embodiment, the control section 300 molds the molded object and the brim structure on the peeling layer PL. On the other hand, the control section 300 may mold the molded object and the brim structure on the stage 210.

(H2) In the above described embodiment, the control section 300 molds the brim layer BL by ejecting the molding material from the nozzle 61 so as to circle around the molding layer ML. On the other hand, the control section 300 may perform the molding so as to be in contact with a part of the molding layer ML without circulating the nozzle 61 around the molding layer ML.

(H3) In the above embodiment, the molding section 110 plasticizes the material by the flat screw 40. On the other hand, for example, the molding section 110 may plasticize the material by rotating an inline screw. The molding section 110 may plasticize filamentous material with a heater.

### I. Other Forms

The present disclosure is not limited to the above described embodiments, and can be realized in various configurations without departing from the spirit thereof. For example, the technical features of the embodiments corresponding to the technical features in each aspect described below can be appropriately replaced or combined in order to solve a part or all of the problems described above or to achieve a part or all of the effects described above. Unless the technical features are described as essential in the present specification, the technical features can be appropriately deleted.

(1) According to a first aspect of the present disclosure, there is provided a three dimensional molded object manufacturing method.

This manufacturing method includes a first step of molding a molded object having a first overhang section by ejecting a first molding material and stacking molding layers and a second step of molding a brim structure by ejecting a second molding material and stacking brim layers, wherein the brim structure includes a first brim layer adjacent to and in contact with at least a part of a molding layer positioned in a lowermost layer of the molded object, and a second brim layer stacked on the first brim layer and that is adjacent to and in contact with at least a part of the first overhang section and the brim structure is a structure to be separated from the molded object that was molded in the first step.

According to such an aspect, the three dimensional molded object can be suppressed from warping because the molded object constituted by the plurality of molding layers and the brim structure constituted by the plurality of brim layers are molded so as to be adjacent to and in contact with each other at least at the lowermost layer.

(2) The above embodiment may be such that the molded object has a constricted portion recessed in a direction intersecting a vertical direction and in the second step, the brim layers are stacked so as not to be adjacent to the constricted portion.

With such an aspect, it is possible to enhance the separability between the molded object having the constricted portion and the brim structure.

(3) The above embodiment may be such that a width of the brim layers in an in-plane direction is a common width for the brim layers constituting the brim structure and in the second step, by stacking the brim layers having the width, the brim structure is molded having a second overhang section that contacts the first overhang section.

With such an aspect, the first overhang section of the molded object can be supported by the second overhang section of the brim structure.

(4) The above embodiment may be such that in the second step, assuming that n is a natural number, when a protruding portion that protrudes by the width or more from a molding region of an nth brim layer counting from the lowermost layer exists in the molding region of the n+1th brim layer counting from the lowermost layer, then the protruding portion is not molded.

With such an aspect, it is possible to suppress the brim structure from collapsing.

(5) The above embodiment may be such that in the second step, when a protruding portion that protrudes outward from the molding region of the first brim layer exists in the molding region of the second brim layer, then the protruding portion is not formed.

With such an aspect, a brim structure with a stable shape can be molded.

(6) The above embodiment may be such that in the second step, assuming that n is a natural number, the brim structure is molded such that a width in an in-plane direction of an n+1th brim layer counting from the lowermost layer is equal to or less than a width in the in-plane direction of an nth brim layer counting from the lowermost layer.

With such an aspect, the brim structure can be stably molded.

(7) The above embodiment may be such that in the second step, the brim layers are molded by ejecting the second molding material along a path circling around the molding layer.

With such an aspect, it is possible to more effectively suppress the occurrence of warp in the molded object.

The present disclosure is not limited to the above described three dimensional molded object manufacturing method, and can be realized by various aspects such as a three dimensional forming system, a three dimensional molding device, a computer program, and a non-transitory tangible recording medium in which the computer program is recorded in a computer-readable manner.

What is claimed is:

1. A three dimensional molded object manufacturing method comprising:
a first step of molding a molded object having a first overhang section by ejecting a first molding material and stacking molding layers and
a second step of molding a brim structure by ejecting a second molding material and stacking brim layers, wherein
the brim structure includes a first brim layer adjacent to and in contact with at least a part of a molding layer positioned in a lowermost layer of the molded object, and a second brim layer stacked on the first brim layer and that is adjacent to and in contact with at least a part of the first overhang section and the brim structure is a structure to be separated from the molded object that was molded in the first step.

2. The three dimensional molded object manufacturing method according to claim 1, wherein
the molded object has a constricted portion recessed in a direction intersecting a vertical direction and
in the second step, the brim layers are stacked so as not to be adjacent to the constricted portion.

3. The three dimensional molded object manufacturing method according to claim 1, wherein
a width of the brim layers in an in-plane direction is a common width for the brim layers constituting the brim structure and
in the second step, by stacking the brim layers having the width, the brim structure is molded having a second overhang section that contacts the first overhang section.

4. The three dimensional molded object manufacturing method according to claim 3, wherein
in the second step, assuming that n is a natural number, when a protruding portion that protrudes by the width or more from a molding region of an nth brim layer counting from the lowermost layer exists in the molding region of the n+1th brim layer counting from the lowermost layer, then the protruding portion is not molded.

5. The three dimensional molded object manufacturing method according to claim 1, wherein
in the second step, when a protruding portion that protrudes outward from the molding region of the first brim layer exists in the molding region of the second brim layer, then the protruding portion is not formed.

6. The three dimensional molded object manufacturing method according to claim 1, wherein
in the second step, assuming that n is a natural number, the brim structure is molded such that a width in an in-plane direction of an n+1th brim layer counting from the lowermost layer is equal to or less than a width in the in-plane direction of an nth brim layer counting from the lowermost layer.

7. The three dimensional molded object manufacturing method according to claim 1, wherein
in the second step, the brim layers are molded by ejecting the second molding material along a path circling around the molding layer.
